(19) United States
(12) Patent Application Publication
(10) Pub. No.: US 2018/0285217 A1
(43) Pub. Date: Oct. 4, 2018

(54) FAILOVER RESPONSE USING A KNOWN GOOD STATE FROM A DISTRIBUTED LEDGER

(71) Applicant: Intel Corporation, Santa Clara, CA (US)

(72) Inventors: NED M. SMITH, BEAVERTON, OR (US); THIAGO J. MACIEIRA, HILLSBORO, OR (US); ZHENG ZHANG, PORTLAND, OR (US); GLEN J. ANDERSON, BEAVERTON, OR (US); IGOR MUTTIK, BERKHAMSTED (GB)

(21) Appl. No.: 15/475,574

(22) Filed: Mar. 31, 2017

(51) Int. Cl. G06F 11/14

(52) U.S. Cl. CPC G06F 11/1489; G06F 2201/84; G06F 11/1458

(57) ABSTRACT

Techniques for repair and/or recovery of computer program(s) installed on a programmable device using a distributed ledger that is based on cryptography and blockchain technology are described. One or more self-reliance logic/modules can commit, to a distributed ledger that resides on interconnected devices, records of watchdog communications between the devices. One or more of interconnected devices may include a respective self-reliance logic/module. The logic/modules can use the records of the distributed ledger to check that computer program(s) on the interconnected devices are operating as expected. When a self-reliance logic/module fails to respond to a watchdog communication, the distributed ledger can be updated to include this failure. A self-reliance logic/module can determine, based on the distributed ledger and/or the failure, that an installed computer program is faulty. Furthermore, a self-reliance logic/module can initiate one or more software recovery services based on the determination. Other advantages and embodiments are described.

### TECHNICAL FIELD

Embodiments described herein generally relate to the field of programmable devices. More particularly, embodiments described herein relate to repairing or recovering a failed computer program (e.g., software, firmware, etc.) installed on one or more interconnected programmable devices.

### BACKGROUND ART

Programmable devices—such as internet of things (IoT) devices, mobile computing devices, cloud computing devices, logical computing devices, virtual computing devices—can make up a computer system comprised of interconnected programmable devices. In such a computer system, each programmable device includes one or more computer programs (e.g., software, firmware, etc.) for performing its operations and functionalities.

As improvements in technology continue to make programmable devices more accessible and efficient, the number of interconnected programmable devices might increase. Consequently, some computer systems may include numerous interconnected programmable devices (e.g., tens, hundreds, thousands, millions, billions, etc.). In such systems, one problem that could arise is a scalability problem. This problem may occur when one or more programmable devices fail due to one or more faulty computer programs installed thereon, which in turn results in a need for recovery or repair of the faulty computer program(s) installed thereon. One current approach taken by an enterprise information technology (IT) system that services a computer system comprised of interconnected devices relies on a central configuration server to update a failed programmable device of the system with a known, good image of a computer program (e.g., software, firmware, etc.) installed on the device. In this current approach, the user of the programmable device plays an important role in notifying the central configuration server when a problem occurs (e.g., when the programmable device fails, etc.). For example, a user of a failed programmable device may open a service call ticket to be serviced by a service facility, and talk to an agent from the service facility who diagnoses the problem and recommends a repair action.

As the number of interconnected programmable devices that make up a computer system increase, these devices may become too numerous for the approach described in the preceding paragraph to work. This is because service facilities may not have enough resources to resolve the numerous devices that could fail. The problem described in this paragraph is further compounded by a potential lack of user interface capabilities on the programmable devices (or on computing systems that are available to the users of failed devices), which could prevent facilitating detection, diagnostics, and repair of the users' devices. An inability to resolve failed devices can, in turn, cause a negative impact on the availability of one or more interconnected devices. Consequently, a lack of resources to enable recovery and repair of computer programs installed on one or more interconnected programmable devices of a computer system may add risks to the operational integrity of the computer system.

The problem described above is also compounded in computer systems comprised of interconnected programmable devices because such systems rely on centralized communication models, otherwise known as the server/client model. The servers used in the server/client model are potential bottlenecks and failure points that can disrupt the functioning of an entire computer system. Additionally, these servers are vulnerable to security compromises (e.g., man-in-the-middle attacks, etc.) because all data associated with the multiple devices of the computer system must pass through the servers. Consequently, a server tasked with recovery or repair of computer programs installed on a failed programmable device may fail, which is undesirable.

### BRIEF DESCRIPTION OF DRAWINGS

FIG. 1 is a block diagram illustrating a computer system comprised interconnected programmable devices according to one embodiment.

FIG. 2 is a sequence diagram illustrating a technique for software recovery of a computer program installed on a programmable device that is part of a computer system of interconnected programmable devices according to one embodiment.

FIG. 3 is a block diagram illustrating software recovery services for repair and recovery of a computer program according to one embodiment.

FIG. 4 is a flowchart illustrating a technique for software recovery of a computer program using a distributed ledger in accord with one embodiment.

FIG. 5 is a block diagram illustrating a programmable device for use with one or more of the techniques described herein according to one embodiment.

FIG. 6 is a block diagram illustrating a programmable device for use with one or more of the techniques described herein according to another embodiment.

### DESCRIPTION OF EMBODIMENTS

Embodiments described herein relate to recovering or repairing computer program(s) installed on one or more interconnected programmable devices of a computer system using a distributed ledger that is available to multiple devices of the computer system. The embodiments described herein have numerous advantages, which are directed to improving computer functionality. One advantage of the embodiments described herein is that these embodiments can assist with addressing the scalability problem described in the background section of this document. For example, one or more of the embodiments described herein can make a failed programmable device in a computer system comprised of interconnected programmable devices auto-recoverable using a distributed ledger that is available to multiple programmable devices in the computer system. For this example, the distributed ledger facilitates a device-driven recovery, failover, or replacement strategy, which may be referred to herein as a “self-reliant” strategy or “self-reliance.” Another advantage of the embodiments described herein is that such embodiments can provide an alternative to the central communication model of repairing or recovering computer programs (i.e., the client/server model). Furthermore, at least one of the embodiments described herein can assist with one or more of the following: (i) minimizing or eliminating failure rates of devices in a computer system comprised of interconnected programmable devices, which in turn assist with preventing other devices in the system from becoming disabled; (ii) minimizing or eliminating risks to the operational integrity of a computer system comprised of interconnected programmable devices caused by failed devices; (iii) minimizing or eliminating the use of servers as the only watchdog devices used for recovering or repairing computer programs installed on interconnected programmable devices of a computer system because such servers are potential bottlenecks and failure points that can disrupt the functioning of an entire computer system; and (iv) minimizing or eliminating vulnerabilities caused by security compromises (e.g., man-in-the-middle attacks, etc.) because the data associated with the multiple interconnected devices of a computer system does not have to be communicated using a centralized communication model.

In the following description, for purposes of explanation, numerous specific details are set forth in order to provide a thorough understanding of the embodiments described herein. It will be apparent, however, to one skilled in the art that the embodiments described herein may be practiced without these specific details. In other instances, structure and devices are shown in block diagram form in order to avoid obscuring the embodiments described herein. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter in the embodiments described herein. As such, resort to the claims is necessary to determine the inventive subject matter in the embodiments described herein. Reference in the specification to “one embodiment,” “an embodiment,” “another embodiment,” or their variations means that a particular feature, structure, or characteristic described in connection with the embodiments is included in at least one of the embodiment described herein, and multiple references to “one embodiment,” “an embodiment,” “another embodiment,” or their variations should not be understood as necessarily all referring to the same embodiment.

As used herein, the term “programmable device” and its variations refer to a physical object that includes electronic components configured to receive, transmit, and/or process data information. For one embodiment, one or more of the electronic components may be embedded within the physical object, such as in wearable devices and mobile devices (e.g., self-driving vehicles). For one embodiment, the device may also include actuators, motors, control functions, sensors, and/or other components to perform one or more tasks without human intervention, such as drones, self-driving vehicles, and/or automated transporters. The programmable device can refer to a computing device, such as (but not limited to) a mobile computing device, a lap top computer, a wearable computing device, a network device, an internet of things (IoT) device, a cloud computing device, a vehicle, a smart lock, etc.

As used herein, the terms a “program,” a “computer program,” and their variations refer to one or more computer instructions are executed by a programmable device to perform a task. Examples include, but are not limited to, software and firmware.

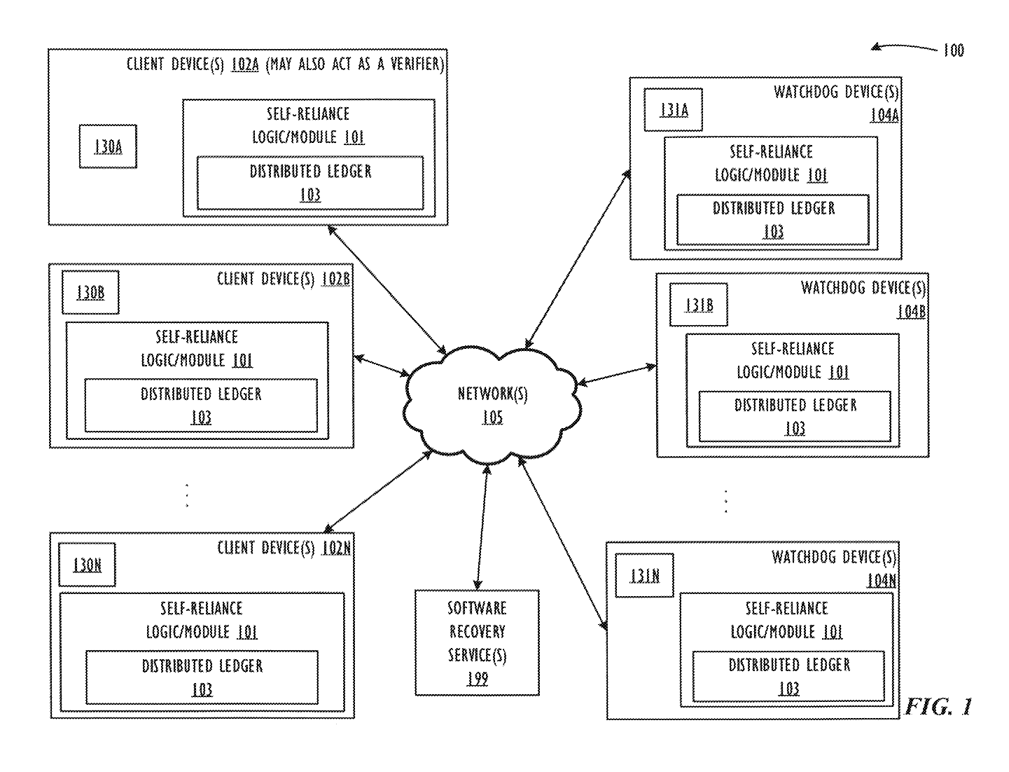

As used herein, “software recovery services,” “software recovery,” “software repair,” “recovery,” “repair,” and their variations refer to modification, re-installation, and/or deletion of a computer program installed on a programmable device to a known, good configuration of the computer program. For brevity, the terms “software recovery” or “software recovery services” will be used to refer to “software recovery services,” “software recovery,” “software repair,” “recovery,” and “repair,” as described herein. Software recovery services include, but are not limited to, a rollback operation to rollback a computer program that is currently installed on a programmable device to the last known, good configuration of the computer program. Examples of rolling back a computer program include, but are not limited to, a major version rollback, a minor version rollback, a patch, a hotfix, a maintenance release, and a service pack. As such, rolling back a computer program includes moving from a version of a computer program to another version, as well as, moving from one state of a version of a computer program to another state of the same version of the computer program. Rollbacks can be used for fixing security vulnerabilities and other bugs, improving the device's functionality by adding new features, improving power consumption and performance, repairing failed programmable devices, etc. Rollbacks may be viewed as important features in the lifecycles of programmable devices. Additional details about software recovery services are described below in connection with one or more of FIGS. 1-4.

As used herein, the term “a computer system” can refer to a single programmable device or a plurality of programmable devices working together to perform a function or an operation described as being performed on or by a computer system. For one embodiment of a computer system comprised of multiple programmable devices, one or more of the devices can perform at least one function or at least one operation that is different from one or more functions or operations that are performed by one or more other devices of the system. For one example, a first device of a computer system can perform a first function or operation that differs from a second function or operation performed by a second device of the computer system. For another embodiment of a computer system comprised of multiple programmable devices, one or more of the devices can have at least one function or at least one operation performed on it that is different from one or more functions or operations that are performed on one or more other devices of the system. For example, a first device of a computer system can have a first function or operation performed on it that differs from a second function or operation that is performed on a second device of the computer system.

As used herein, a “computer network,” a “network,” and their variations refer to a plurality of interconnected programmable devices that can exchange data with each other. For example, a computer network can enable a computer system comprised of interconnected programmable devices to communicate with each other. Examples of computer networks include, but are not limited to, a peer-to-peer network, any type of data network such as a local area network (LAN), a wide area network (WAN) such as the Internet, a fiber network, a storage network, or a combination thereof, wired or wireless. In a computer network, interconnected programmable devices exchange data with each other using a communication mechanism, which refers to one or more facilities that allow communication between devices in the network. The connections between interconnected programmable devices are established using either wired or wireless communication links. The communication mechanisms also include networking hardware (e.g., switches, gateways, routers, network bridges, modems, wireless access points, networking cables, line drivers, switches, hubs, repeaters, etc.).

As used herein, a “watchdog system,” a “watchdog device,” a “watchdog,” and their variations refer to hardware (e.g., one or more processing units, electronic circuitry, etc.), software (e.g., a computer program executed by one or more processing units or electronic circuitry, etc.), or a combination of both that sends out messages (e.g., a signal, a ping packet, etc.) to a programmable device on a periodic basis with the aim of receiving a response from the programmable device. When the watchdog does not receive a response to its message from the programmable device within a predetermined period of time, then the watchdog device can initiate one or more software recovery services for the device that failed to respond to the watchdog device as described in connection with one or more of the embodiments set forth herein. The predetermined period of time can be based on at a time from when the watchdog message was transmitted by the watchdog device or a time from when the watchdog message was received by the client device. For one embodiment, the watchdog device is a programmable device configured to perform the operations described in this paragraph.

As used herein, a “watchdog message,” a “watchdog ping,” a “message,” a “ping,” and their variations refer to a signal that is sent by a watchdog device to a programmable device in a computer system comprised of interconnected programmable devices, which the programmable device must respond to within a predetermined amount of time to indicate that a computer program installed on the programmable device is operating without fault (e.g., the program is operating as expected, etc.). A response to the watchdog message may also be referred to herein as a “watchdog response message.”

As used herein, the term “distributed ledger” and its variations refer to a database that is available to multiple programmable devices and/or multiple watchdogs of a computer system comprised of interconnected programmable devices. One key feature of a distributed ledger is that there is no central data store where a master copy of the distributed ledger is maintained. Instead, the distributed ledger is stored in many different data stores, and a consensus protocol ensures that each copy of the ledger is identical to every other copy of the distributed ledger. A distributed ledger can, for example, be based on a blockchain-based technology, which is known in the art of cryptography and cryptocurrencies (e.g. bitcoin, etherium, etc.). The distributed ledger may provide a publically and/or non-publically verifiable ledger used for software recovery in one or more programmable devices and/or one or more watchdog devices in a computer system comprised of interconnected programmable devices. Changes in the distributed ledger (e.g., successful responses to watchdog messages, failed responses to watchdog messages, etc.) represent working conditions of one or more computer programs installed on one or more programmable devices of a computer system comprised of interconnected programmable devices. These changes may be added to and/or recorded in the distributed ledger. For one embodiment, multiple programmable devices and/or watchdog devices of a computer system comprised of interconnected programmable devices are required to validate changes, add them to their copy of the distributed ledger, and broadcast their updated distributed ledger to the entire computer system. Each of the programmable devices and/or watchdog devices having the distributed ledger may validate changes according to a validation protocol. For one embodiment, the validation protocol defines a process by which the interconnected devices of the computer system that comprises interconnected programmable devices agree on changes and/or additions to the distributed ledger. For one embodiment, the validation protocol may include the proof-of-work protocol implemented by Bitcoin or a public consensus protocol. For another embodiment, the validation protocol may include a private and/or custom validation protocol. The distributed ledger enables the interconnected devices in a computer system comprised of interconnected programmable devices to agree via the verification protocol on one or more changes and/or additions to the distributed ledger (e.g., to include successful responses to watchdog messages, to include failed responses to watchdog messages, etc.).

FIG. 1 is a block diagram illustrating a computer system 100 comprised of interconnected programmable client devices 102A-N (hereinafter “client devices 102A-N”) according to one embodiment. As shown, the computer system 100 includes multiple client devices 102A-N, multiple programmable watchdog devices 104A-N (hereinafter “watchdog devices 104A-N”), one or more software recovery services 199, and one or more networks 105.

Each of the client devices 102A-N can be an internet of things (IoT) device, a mobile computing device, a cloud computing device, a logical computing device, or a virtual computing device. Also, each of the client devices 102A-N can include electronic components 130A-N. Examples of the components 130A-N include: processing unit(s) (such as microprocessors, co-processors, other types of integrated circuits (ICs), etc.); corresponding memory; and/or other related circuitry. For one embodiment, each of the client devices 102A-N includes a corresponding one of the self-reliance logic/modules 101, which implements a distributed ledger 103. The ledger 103 is used for software recovery of one or more computer programs installed on one or more of the client devices 102A-N. The distributed ledger 103 can, for one embodiment, be distributed across at least two of the devices 102A-N and 104A-N. In this way, the distributed ledger 103 may be used to avoid one or more shortcomings of a central communication technique used for software recovery of computer programs (i.e., the server/client model). Furthermore, and as shown in FIG. 1, for one embodiment, the distributed ledger 103 is replicated on and available to the client devices 102A-N and the watchdog devices 104A-N. Thus, for this embodiment, each of the watchdog devices 104A-N includes a corresponding self-reliance logic/module 101 that is similar to the self-reliance logic/modules 101 described in connection with FIGS. 1-6 throughout this document.

Each of the self-reliance logic/modules 101 can be implemented as at least one of hardware (e.g., electronic circuitry of the processing unit(s), dedicated logic, etc.), software (e.g., one or more instructions associated with a computer program executed by the processing unit(s), software run on a general-purpose computer system or a dedicated machine, etc.), or a combination thereof. For one embodiment, each of the self-reliance logic/modules 101 performs one or more embodiments of techniques for software recovery of a computer program installed on one or more interconnected client devices 102A-N, as described herein.

For some embodiments, each of the self-reliance logic/modules 101 of the client devices 102A-N is implemented as one or more special-purpose processors with tamper resistance features. These types of specialized processors are commonly known as tamper resistant processors. Examples of such special-purpose processors include a trusted platform module (TPM) cryptoprocessor, an application specific integrated circuit (ASIC), an application-specific instruction set processor (ASIP), a field programmable gate array (FPGA), a digital signal processor (DSP), any type of cryptographic processor, an embedded processor, a co-processor, or any other type of logic with tamper resistance features that is capable of processing instructions. In this way, the self-reliance logic/modules 101 and the distributed ledger 103 can be implemented and maintained in a secure manner that assists with minimizing or preventing security vulnerabilities, as well as with improving the resilience of the client devices 102A-N against software failure. For a further embodiment, the self-reliance logic/modules 101 and/or the distributed ledger 103 may be maintained separately from the components 130A-N. For example, the self-reliance logic/modules 101 may be implemented as one or more special-purpose processors that is separate from the components 130A-N.

In the computer system 100, each of the client devices 102A-N includes one or more computer programs (e.g., software, firmware, etc.) for performing its operations and functionalities. Furthermore, each of the client devices 102A-N's computer program(s) may be rolled back as the computer program(s) fail and/or become faulty. These rollbacks are usually in the form of major version rollbacks, minor version rollbacks, patches, hotfixes, maintenance releases, service packs, etc. The goal of rolling back computer program(s) installed on the programmable devices 102A-N is to bring such a device back to know, good operational state (prior to the failure or faulty operation of the client device). Rollbacks can assist with fixing security vulnerabilities and other bugs, returning the device's functionality back to usable operational states, or returning power consumption and performance back to a normal state. Such rollbacks, therefore, can be viewed as important features in the lifecycles of IoT devices, mobile computing devices, cloud computing devices, logical computing devices, and virtual computing devices.

For a specific embodiment, each of the self-reliance logic/modules 101 is implemented in a trusted execution environment (TEE) of one or more processors of the client devices 102A-N. Examples of TEEs can be included in processors and/or cryptoprocessors based on Intel Software Guard Extensions (SGX) technology, processors and/or cryptoprocessors based on Intel Converged Security and Manageability Engine (CSME) technology, processors and/or cryptoprocessors based on Intel Trusted Execution Technology (TXT) technology, processors and/or cryptoprocessors based on Trusted Platform Module (TPM) technology, processors and/or cryptoprocessors based on ARM TrustZone technology, etc. In this way, the TEE acts as an isolated environment for the distributed ledger 103 that runs in parallel with the other computer programs (e.g., software, firmware, etc.) installed on the client devices 102A-N. For one example, a self-reliance logic/module 101 can be implemented in TEE of a TPM cryptoprocessor, an ASIC, an ASIP, an FPGA, a DSP, any type of cryptographic processor, an embedded processor, a co-processor, or any other type of logic with tamper resistance features that is capable of processing instructions.

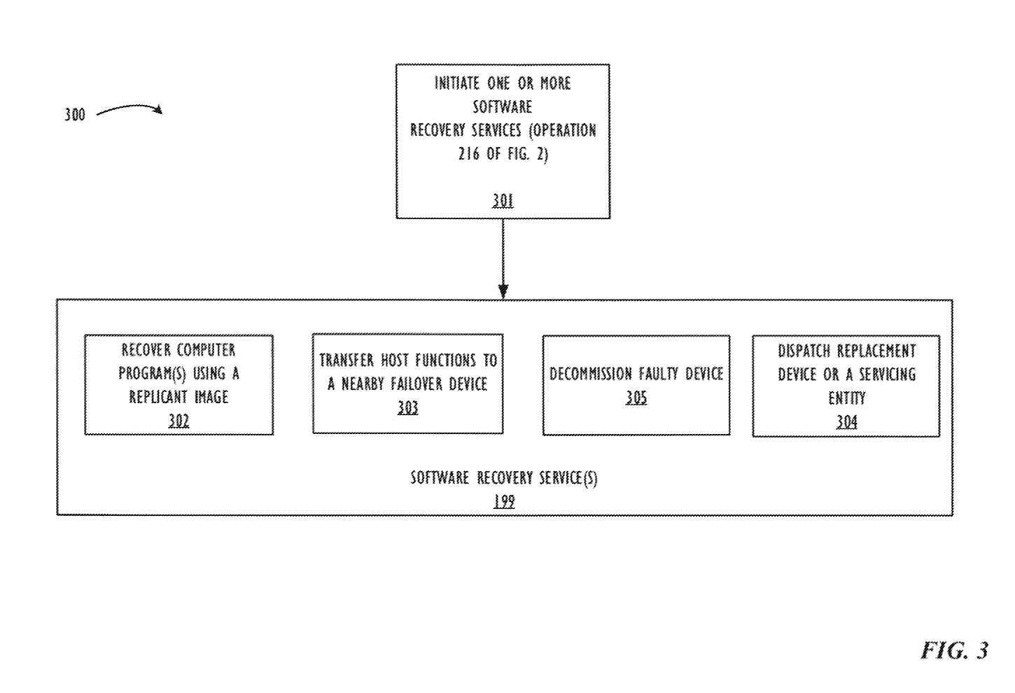

Each of the watchdog devices 104A-N in the computer system 100 is a computer system that executes various types of processing including transmission of watchdog messages and receipt thereof. Also, each of the watchdog devices 104A-N can include electronic components 131A-N. Examples of the components 131A-N include: processing unit(s) (such as microprocessors, co-processors, other types of integrated circuits (ICs), etc.); corresponding memory; and/or other related circuitry. As such, each of the watchdog devices 104A-N can be any of various types of computers, including general-purpose computers, workstations, personal computers, servers, etc. For one embodiment, the watchdog devices 104A-N in the computer system 100 are associated with an external entity (e.g., a service facility that provides software recovery services 199, etc.). As such, the watchdog devices 104A-N can assist with delivery of software recovery service(s) 199 without having a user contact a service facility that provides software recovery services 199 to initiate software recovery operations. Examples of a service facility that provides software recovery services 199 includes, but is not limited to, Internet-based service facilities that facilitate software recovery of computer programs installed on one or more client devices 102A-N. Additional details about software recovery services 199 are discussed below in connection with at least FIG. 3. For one embodiment, the description provided herein with regard to the self-reliance logic/modules 101 (and the distributed ledger 103) of the client devices 102A-N applies to the self-reliance logic/modules 101 (and the distributed ledger 103) of the watchdog devices 104A-N. For example, and for one embodiment, each of the self-reliance logic/modules 101 of the watchdog devices 104A-N is implemented as one or more special-purpose processors with tamper resistance features. Special-purpose processors are described above. For another example, and for one embodiment, each of the self-reliance logic/modules 101 of the watchdog devices 104A-N is implemented in TEE of one or more processors of the watchdog devices 104A-N.

A rollback, for some embodiments, can be in the form of a software image (e.g., a disk image, a process image, etc.). For other embodiments, a rollback can be in the form of a bundle (e.g., a directory with a standardized hierarchical structure that holds executable code and the resources used by that code, etc.).

The client devices 102A-N and the watchdog devices 104A-N communicate within the computer system 100 via one or more networks 105. These network(s) 105 comprise one or more different types of computer networks, such as the Internet, enterprise networks, data centers, fiber networks, storage networks, WANs, and/or LANs. Each of the networks 105 may provide wired and/or wireless connections between the devices 102A-N and the watchdog devices 104A-N that operate in the electrical and/or optical domain, and also employ any number of network communication protocols (e.g., TCP/IP). For example, one or more of the networks 105 within the computer system 100 may be a wireless fidelity (Wi-Fi®) network, a Bluetooth® network, a Zigbee® network, and/or any other suitable radio based network as would be appreciated by one of ordinary skill in the art upon viewing this disclosure. It is to be appreciated by those having ordinary skill in the art that the network(s) 105 may also include any required networking hardware, such as network nodes that are configured to transport data over network(s) 105. Examples of network nodes include, but are not limited to, switches, gateways, routers, network bridges, modems, wireless access points, networking cables, line drivers, switches, hubs, and repeaters. For embodiment, at least one of the client devices 102A-N and/or at least one of the watchdog devices 104A-N implements the functionality of a network node.

One or more of the networks 105 within the computer system 100 may be configured to implement computer virtualization, such as virtual private network (VPN) and/or cloud based networking. For one embodiment, at least one of the client devices 102A-N and/or at least one of the watchdog devices 104A-N comprises a plurality of virtual machines (VMs), containers, and/or other types of virtualized computing systems for processing computing instructions and transmitting and/or receiving data over network(s) 105. Furthermore, at least one of the client devices 102A-N and/or at least one of the watchdog devices 104A-N may be configured to support a multi-tenant architecture, where each tenant may implement its own secure and isolated virtual network environment. Although not illustrated in FIG. 1, the computer system 100 can enable at least one of the client devices 102A-N and/or at least one of the watchdog devices 104A-N to connect to a variety of other types of programmable devices, such as VMs, containers, hosts, storage devices, wearable devices, mobile devices, and/or any other device configured to transmit and/or receive data using wired or wireless network(s) 105.

For some embodiments, the network(s) 105 comprise a cellular network for use with at least one of the client devices 102A-N and/or at least one of the watchdog devices 104A-N. For this embodiment, the cellular network may be capable of supporting of a variety of the client devices 102A-N and/or the watchdog devices 104A-N that include, but are not limited to computers, laptops, and/or a variety of mobile devices (e.g., mobile phones, self-driving vehicles, ships, and drones). The cellular network can be used in lieu of or together with at least one of the other networks 105 described above. Cellular networks are known so they are not described in detail in this document.

In some situations, the computer program(s) installed on the client devices 102A-N are meant to operate without any setbacks or negative ramifications. However, one or more of these computer programs can sometimes introduce problems (e.g., faulty operation of a device, disabling of the device, etc.). In some scenarios, a faulty computer program installed on a single one of the client devices 102A-N (e.g., client device 102A, etc.) can disable one or more client devices 102A-N (e.g., one or more client devices 102B-N, etc.), which can in turn cause risks to the operational integrity of the computer system 100. Software recovery service(s) 199 can be used to assist with resolving a faulty computer program that is installed on one or more of the client devices 102A-N by re-installing previous versions of the installed computer program that were known to operate as intended.

The distributed ledger 103, as implemented by the self-reliance logic/modules 101, can assist with minimizing or eliminating at least one of the problems described in the immediately preceding paragraph. This is because the distributed ledger 103 operates based on the concept of decentralized consensus, as opposed to the currently utilized concept of centralized consensus. Centralized consensus is the basis of the client/server model and it requires one central database or server for deciding how or which software recovery service(s) are provided to the client device(s) 102A-N, and as a result, this can create a single point of failure that is susceptible to security vulnerabilities. In contrast, the distributed ledger 103 operates based on a decentralized scheme that does not require a central database for deciding how or which software recovery service(s) are provided to one or more of the client devices 102A-N. For one embodiment, the computer system 100 enables its nodes (e.g., the client devices 102A-N, the watchdog devices 104A-N, etc.) to continuously and sequentially record the watchdog communications between the client devices 102A-N and the watchdog devices 104A-N in a unique chain—that is, in the distributed ledger 103. For one embodiment, the distributed ledger 103 is an append-only record of the watchdog communications between the client devices 102A-N and the watchdog devices 104A-N that is based on a combination of cryptography and blockchain technology. For this embodiment, each successive block of the distributed ledger 103 comprises a unique fingerprint of an immediately preceding watchdog communication between the client devices 102A-N and the watchdog devices 104A-N. This unique fingerprint can be include at least one of: (i) a hash as is known in the art of cryptography (e.g., SHA,, RIPEMD, Whirlpool, Scrypt, HAS-160, etc.); or (ii) a digital signature generated with a public key, a private key, or the hash as is known in the art of generating digital signatures. Examples of digital signature algorithms include secure asymmetric key digital signing algorithms. One advantage of the distributed ledger 103 is that it can assist with software recovery even in instances when a portion of the computer system 100 is unavailable, which in turn removes the need for the central database or server that is required in the client/server model. Another advantage of the distributed ledger 103 is that it can assist with software recovery even in instances when users of failed client devices 102A-N have not contacted a service facility that can provide software recovery service(s) 199, which can in turn assist with automatic software recovery of failed client devices 102A-N in the computer system 100 and with improving resilience against failure within the computer system 100. Yet another advantage of the distributed ledger 103 is that it can prevent unnecessary rollback operations from being performed on a failed one of the client devices 102A-N. In particular, the distributed ledger 103 can assist with ensuring that a rollback operation is performed no more than once on a failed one of the client devices 102A-N. For example, when the client device 102A receives a first watchdog message from the watchdog device 104A and a second watchdog message from the watchdog device 104B at or around the same time, the self-reliance logic/module 101 records a response from the client device 102A to either one of the watchdog messages as a response to both messages in the distributed ledger 103. For this example, the records created by the self-reliance logic/module 101 in the distributed ledger 103 are communicated via the network(s) 105 to every other copy of the distributed ledger 103 that is stored on or available to the other self-reliance logic/module 101. In this way, and for this example, the distributed ledger 103 enables all of the client devices 102A-N and/or the watchdog devices 104A-N to maintain a record of responses to watchdog messages, which can assist with determining points of failure and initiating software recovery service(s) 199.

The distributed ledger 103, as a blockchain, includes information stored in its header that is accessible to the client devices(s) 102A-N and/or the watchdog devices 104A-N, which enables the client devices(s) 102A-N and/or the watchdog devices 104A-N to “view” one or more of: (i) watchdog messages that have been transmitted to the client devices(s) 102A-N by the watchdog devices 104A-N; and (ii) responses to the watchdog messages that have been transmitted by the client devices(s) 102A-N to the watchdog devices 104A-N. In this way, the distributed ledger 103 is a software design approach that binds the client devices 102A-N and/or the watchdog devices 104A-N together such that commonly obey the same consensus process for releasing or recording what information they hold, and where all related interactions are verified by cryptography. The distributed ledger 103 can be a private blockchain or a public blockchain. Furthermore, the distributed ledger 103 can be a permissioned blockchain or a permissionless blockchain.

One issue associated with distributed ledgers that are based on blockchain technology is that they are resource-intensive. That is, they require a large amount of processing power, storage capacity, and computational resources that grow as the ledger is replicated on more and more devices. This issue is based, at least in part, on the requirement that every node or device that includes a ledger must process every transaction in order to ensure security, which can become computationally expensive. As such, each device that includes the ledger may require access to a sizable amount of computational resources. On programmable devices with fixed or limited computational resources (e.g., mobile devices, vehicles, smartphones, lap tops, tablets, and media players, microconsoles, IoT devices, etc.), processing a ledger may prove difficult.

At least one embodiment of the distributed ledger 103 described herein can assist with minimizing the resource-intensive issue described above. For one embodiment, the distributed ledger 103 is not constructed as a monolithic blockchain with all of its blocks existing on all of the client devices 102A-N and/or the watchdog devices 104A-N. Instead, the distributed ledger 103 is constructed as a light ledger based on, for example, the light client protocol for the ethereum blockchain, the light client protocol for the bitcoin blockchain, etc. In this way, the distributed ledger 103 may be replicated on the client devices 102A-N and/or the watchdog devices 104A-N on an as-needed basis. For one embodiment, any one of the client devices 102A-N and/or the watchdog devices 104A-N that is resource-constrained will only store the most recent blocks of the ledger 103 (as opposed to all of the blocks of the ledger 103). For this embodiment, the number of blocks stored by a particular device or entity can be determined dynamically based on its storage and processing capabilities. For example, any one of the client devices 102A-N and/or the watchdog devices 104A-N can store (and also process) only the current block and the immediately following block of the ledger 103. This ensures that any consensus protocols required to add new blocks to ledger 103 can be executed successfully without requiring all the client devices 102A-N and/or the watchdog devices 104A-N to store the ledger 103 as a large monolithic blockchain. For another embodiment, each block of a ledger 103 may be based on a light client protocol such that the block is broken into two parts: (a) a block header showing metadata about which one of the watchdog communications (i.e., watchdog messages and responses to the watchdog messages) was committed to the block; and (b) a transaction tree that contains the actual data for the committed watchdog communication in the block. For this embodiment, the block header can include at least one of the following: (i) a hash of the previous block's block header; (ii) a Merkle root of the transaction tree; (iii) a proof of work nonce; (iv) a timestamp associated with the committed watchdog communication in the block; (v) a Merkle root for verifying existence of the committed watchdog communication in the block; or (vi) a Merkle root for verifying which one of the client device 102A-N and/or watchdog devices 104A-N generated the committed watchdog communication. For this embodiment, the client devices 102A-N and/or the watchdog devices 104A-N having the ledger 103 can use the block headers to keep track of the entire ledger 103, and request a specific block's transaction tree only when processing operations need to be performed on the ledger 103 (e.g., adding a new block to the ledger 103, etc.). For yet another embodiment, the ledger 103 can be made more resource-efficient by being based on the epoch Slasher technique associated with the light client protocol for the ethereum blockchain.

In some instances, a blockchain synchronization algorithm is required to maintain the ledger 103 across the client devices 102A-N and/or the watchdog devices 104A-N. Here, the blockchain synchronization algorithm enables nodes of the computer system 100 (e.g., one or more of the client devices 102A-N and/or the watchdog devices 104A-N) to perform a process of adding transactions to the ledger 103 and agreeing on the contents of the ledger 103. The blockchain synchronization algorithm allows for one or more of the client devices 102A-N and/or the watchdog devices 104A-N to use the ledger 103, as a block chain, to distinguish legitimate transactions (i.e., watchdog communications comprised of watchdog messages and responses thereof) from attempts to compromise or include false/faulty/flawed information by an attacker (e.g., man-in-the-middle attacks, etc.) in the computer system 100.

Executing the blockchain synchronization algorithm is designed to be resource-intensive so that the individual blocks of the ledger 103 must contain a proof to be considered valid. Examples of proofs include, but are not limited to, a proof of work and a proof of stake. Each block's proof is verified by the client devices 102A-N and/or the watchdog devices 104A-N when they receive the block. In this way, the blockchain synchronization algorithm assists with allowing the client devices 102A-N and/or the watchdog devices 104A-N to reach a secure, tamper-resistant consensus. For one embodiment, the blockchain synchronization algorithm is embedded in the computer system 100 and performed by at least one of the client devices 102A-N and/or the watchdog devices 104A-N. For example, one or more of the client devices 102A-N and/or the watchdog devices 104A-N may include an FPGA or other type of processor that is dedicated to performing and executing the blockchain synchronization algorithm. For this example, the FPGA or other type of processor generates the proofs for the blocks to be included in the ledger 103. Also, and for this example, the blocks are added to the ledger 103 only through verification and consensus (as described above). The blockchain synchronization algorithm can be performed by: (i) any of the client devices 102A-N and/or the watchdog devices 104A-N; or (ii) multiple of the devices 102A-N and/or the watchdog devices 104A-N. For a further embodiment, generating proofs for new blocks is performed in response to automatically determining the complexity of the operation given the availability of resources in the computer system 100. In this way, the resources of the computer system 100 can be utilized more efficiently.

For another embodiment, the blockchain synchronization algorithm is performed outside of the computer system 100 by, for example, a synchronization device (not shown). This synchronization device can be paired to one or more of the client devices 102A-N and/or the watchdog devices 104A-N having the ledger 103. For example, one or more of the client devices 102A-N may be paired via network(s) 105 to a synchronization device outside the system 100. For this example, the synchronization device includes electronic components that are similar to components 130A-N (which are described above). Also, and for this example, each transaction is communicated to the synchronization device via the network(s) 105 using one or more secure communication techniques. Here, the synchronization device generates the proof required for verification and consensus and communicates it back to the system 100. For one embodiment, each transaction comprises one or more of: (i) a watchdog message; (ii) a record of a transmitted or received watchdog message; (iii) a response to a watchdog message; and (iv) a record of a transmitted or received response to a watchdog message.

For yet another embodiment, the ledger 103 may be maintained across the system 100 without using the blockchain synchronization algorithm. As a first example, the ledger 103 may be implemented as a distributed database. For a second example, the ledger 103 may be maintained across the system 100 as a distributed version control system (DVCS), which is also sometimes known as a distributed revision control system (DVRS). Examples of a DVCS include, but are not limited to, ArX, BitKeeper, Codeville, Dares, DCVS, Fossil, Git, and Veracity.

The ledger 103 can also be made as a combination of the immediately preceding embodiments. For one embodiment, the ledger 103 is implemented with the blockchain synchronization algorithm in response to determining that resources of the system 100 are sufficient for the resource-intensive synchronization process. For this embodiment, the ledger 103 is implemented without the blockchain synchronization algorithm in response to determining that resources of the system 100 are not enough for the synchronization process.

Enabling the client devices 102A-N and/or enabling the watchdog devices 104A-N to record watchdog communications (e.g., a watchdog message, a response to a watchdog message, etc.) to the ledger 103 can be based on the enhanced privacy identification (EPID) protocol, e.g., the zero-knowledge proof protocol. For an embodiment based on the zero-knowledge proof protocol, one or more of the client devices 102A-N and/or the watchdog devices 104A-N (e.g., device 102A, device 104A, etc.) acts as a verifier that determines whether other ones of the client devices 102A-N and/or the watchdog devices 104A-N are members of a group of devices that have been granted the privilege to have their actions processed and added to the blockchain represented as the ledger 103. For this embodiment, each of the client devices 102A-N and/or the watchdog devices 104A-N that has privilege to access the ledger 103 cryptographically binds its corresponding public-key to the zero-knowledge proof sent to the verifier, resulting in that public-key being recognized as an identity that has obtained permission to perform actions on the blockchain represented as the ledger 103. For one embodiment, the client device(s) 102A-N and/or the watchdog device(s) 104A-N acting as the verifier adds the verified public-key to the ledger 103. Thus, the ledger 103 can maintain its own list of client devices 102A-N and/or watchdog devices 104A-N that can interact with the ledger 103. In this way, the client device(s) 102A-N and/or the watchdog device(s) 104A-N acting as the verifier ensures that any of the devices 102A-N and/or watchdog devices 104A-N that writes to the ledger 103 is authorized to do so.

To assist with security, and for one embodiment, the ledger 103 can be accessible to the watchdog device(s) 104A-N only via public key cryptography. Here, public keys associated with the ledger 103 can be disseminated to the watchdog device(s) 104A-N, on an as-needed basis, with private keys associated with the ledger 103, which would be known only to users of the client devices 102A-N. In this way, public key cryptography can be used for two functions: (i) using the public key to authenticate that a watchdog message originated with one of the watchdog devices 104A-N that is a holder of the paired private key; or (ii) encrypting a watchdog message provided by one of the watchdog devices 104A-N with the public key to ensure that only the client devices 102A-N, which would be the holders of the paired private key can decrypt and respond to the watchdog message. For example, and for one embodiment, the watchdog device 104A cannot commit watchdog communications (e.g., a watchdog message, a response to a watchdog message, etc.) to the ledger 103 unless the watchdog device 104A is granted access to the ledger 103 via public key cryptography and/or unless the watchdog entity 104A has been verified via the zero proof protocol described above. While, the public key may be publicly available to the watchdog devices 104A-N, a private key and/or prior verification via the zero proof protocol will be necessary to commit watchdog communications (e.g., a watchdog message, a response to a watchdog message, etc.) to the ledger 103. For this example, the private key can be provided to the watchdog device 104A via the network(s) 105 by the logic/module 101 of client device 102A in response to input provided to the client device 102A by a user. Based on a combination of public key cryptography and/or the verification via the zero proof protocol, the watchdog device 104A is enabled to commit watchdog communications (e.g., a watchdog message, a response to a watchdog message, etc.) to the ledger 103. As shown by the immediately preceding example, only users of the client devices 102A-N can provide the watchdog devices 104A-N with access to the ledger 103. This has an advantage of minimizing or eliminating the risk of security vulnerabilities (e.g., man-in-the-middle attacks, eavesdropping, unauthorized data modification, denial-of-service attacks, sniffer attacks, identity spoofing, etc.) because the users will always know which ones of watchdog devices 104A-N has been granted to their devices 102A-N via the ledger 103. For one embodiment, the private key can include information that grants the watchdog devices 104A-N with access to the ledger 103 for a limited period of time (e.g., 10 minutes, 1 hour, any other time period, etc.). Thus, security is further bolstered by preventing watchdog device(s) 104A-N from having unfettered access to the devices 102A-N and/or the ledger 103.

One feature of the distributed ledger 103, which is based on blockchain technology, is the ability to resolve forks attributable to the devices 102A-N and/or the watchdog devices 104A-N that have access to the ledger 103 attempting to add blocks to the end of the chain by finding a nonce that produces a valid hash for a given block of data. When two blocks are found that both claim to reference the same previous block, a fork in the chain is created. Some of the devices 102A-N and/or the watchdog devices 104A-N in the system 100 will attempt to find the next block on one end of the fork while other ones of the devices 102A-N and/or the watchdog devices 104A-N in the system 100 will work from the other end of the fork. Eventually one of the forks will surpass the other in length, and the longest chain is accepted by consensus as the valid chain. This is usually achieved using a consensus algorithm or protocol. Therefore, intruders attempting to change a block must not only re-find a valid hash for each subsequent block, but must do it faster than everyone else working on the currently accepted chain. Thus, after a certain number of blocks have been chained onto a particular block, it becomes a resource-intensive task to falsify contents of a block, which assists with minimizing or eliminating security vulnerabilities. For one embodiment, this ability to resolve forks can be used to perform rollback operations that are necessary to deal with one or more faulty computer programs.

Detecting flaws in the configurations of the computer program may occur as a result of audits, forensics, or other investigation of configurations installed on the client devices 102A-N. The investigation can include, but is not limited, investigations performed based on information recorded into the ledger 103. The one or more logic/modules 101 can detect a flaw in a computer program installed on the client devices 102A-N using one or more software configuration management (SCM) techniques. One example of an SCM technique is a watchdog timing technique and/or a heartbeat timing technique that can be used to detect a flaw that results from a computer program installed on the client devices 102A-N. A watchdog timing technique includes, for example, the client device 102A periodically resetting a timer before the timer expires to indicate that there are no errors in the operation of the device 102A. When the client device 102A does not reset its timer, it is assumed that the operation of device 102A is flawed. Thus, the one or more logic/modules 101 can detect the flaw in a computer program installed on the client device 102A when the one or more logic/modules 101 determine that the client device 102A failed to reset its timer during execution of a computer program. A heartbeat timing technique generally includes the client device 102A transmitting a heartbeat signal with a payload to another device (e.g., any of watchdog devices 104, etc.) in the computer system (e.g., system 100, etc.) to indicate that the device 102A is operating properly. Thus, one or more logic/modules 101 can detect the flaw in a computer program installed on client device 102A when the one or more logic/modules 101 determine that the client device 102A failed to transmit its heartbeat signal on time during execution of an installed computer program by the client device 102A. The watchdog timing technique and/or the heartbeat timing technique can be implemented in a processor (e.g., fault-tolerant microprocessor, etc.) of the client device 102A. For another example of an SCM technique, exception handling techniques (e.g., language level features, checking of error codes, etc.) can be used by the logic/module 101 to determine that a computer program installed on the client device 102A is flawed. For a specific example of an exception handling technique that applies when the client device 102A includes or executes a script, the one or more logic/modules 101 can determine that the computer program installed on the client device 102A is flawed when the one or more logic/modules 101 determine that the client device 102A failed to output or return a result message (e.g., an exit status message, a result value, etc.) to indicate that the script was successfully run or executed during execution of the installed computer program by the client device 102A. The one or more logic/modules 101 can request the result message from the processor(s) of the client device 102A running or executing the script. In response to detecting the flawed computer program, at least one of the logic/modules 101 can initiate performance of a rollback operation to return the computer program to a previous state—that is, to return the computer program from a defective state to a properly functioning state recorded in a block of the ledger 103. This is important in situations where the actual effect of an update may be unknown or speculative, which could result in a computer program that is in an inconsistent state.

For one embodiment, the operations performed in the immediately preceding paragraph are performed in response one or more logic/modules 101 inspecting the ledger 103 to determined that a client device (e.g., the client device 102A, etc.) failed to respond to a watchdog message or failed to transmit a watchdog response message within a predetermined amount of time. For a further embodiment, the logic/modules 101 communicate messages to each other to report that a client device (e.g., the client device 102A, etc.) failed to respond to a watchdog message or failed to transmit a watchdog response message within a predetermined amount of time. When the logic/module 101 of the faulty client device (e.g., the client device 102A, etc.) receives the message reporting the faulty device, then the logic/module 101 of the faulty client device can initiate one or more software recovery services 199.

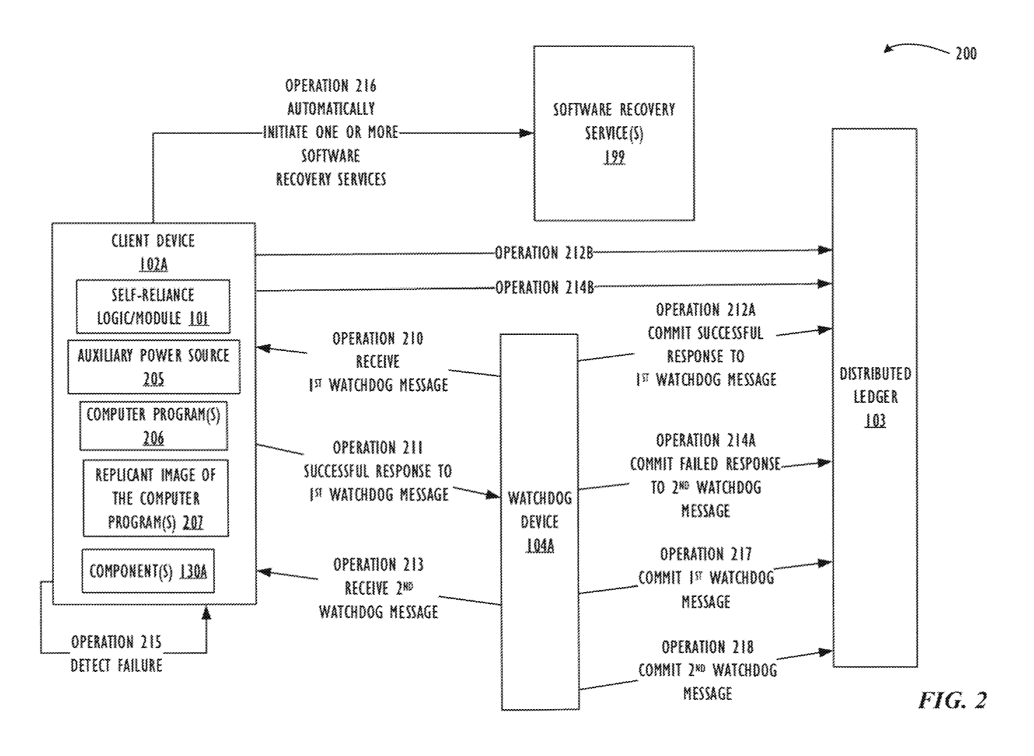

FIG. 2 is a sequence diagram illustrating a technique 200 for software recovery of a computer program installed on a programmable device 102A that is part of a computer system comprised of interconnected programmable devices (e.g., system 100) according to one embodiment. The technique 200 can be performed by one or more elements of the system 100 described above in connection FIG. 1, for example, a TEE implementing a self-reliance logic/module (e.g., the self-reliance logic/module 101 described above in connection with FIG. 1, etc.). Technique 200 includes some elements of the system 100 described above in connection with FIG. 1. For brevity, some of these elements are not described again.

In FIG. 2, a more detailed version of the client device 102A is illustrated. Any one of the client devices 102A-N in FIG. 1 can be the same as or similar to the client device 102A in FIG. 2. The client device 102A shown in FIG. 2 includes the self-reliance logic/module 101, an auxiliary power source 205 for powering the logic/module 101 independently of the other component(s) 130A of the client device 102A, one or more computer programs 206 installed on the client device 102A, a replicant image 207 of the computer program(s) (which is a copy of the computer program(s) 206), and component(s) 130A (which are described above in connection with FIG. 1).

Technique 200 begins at operation 210, where a watchdog device 104A sends a first watchdog message to the client device 102A. One embodiment of technique 200 can optionally include operation 217, which includes the watchdog device 104A committing a record of the first watchdog message being sent to the distributed ledger 103. Next, at operation 211, the self-reliance logic/module 101 in the client device 102A can respond to the first watchdog message within a predetermined period of time to indicate that the computer program(s) 206 are operating without any issues (i.e., as expected). As shown, operations 212A-B include a record of the successful response to the first watchdog message being committed to the ledger 103. Operation 212A can be performed by the watchdog device 104A and operation 212B can be performed by the self-reliance logic/module 101 of the client device 102A. For one embodiment, only of one of operations 212A-B is performed. For another embodiment, both operations 212A-B are performed.

Technique 200 further includes operation 213, where the watchdog device 104A communicates a second watchdog message to the self-reliance logic/module 101 of the client device 102A. One embodiment of the technique 200 can optionally include operation 218, which includes the watchdog device 104A committing a record of the second watchdog message being sent to the distributed ledger 103. As shown in FIG. 2, the self-reliance logic/module 101 fails to respond to the second watchdog message within a second predetermined period of time that is substantially equal to or is equal to the first predetermined period of time described above in connection with operation 211. This failure can indicate that the computer program(s) 206 are not performing as properly (i.e., as expected), and/or that the client device 102A may have failed as a result of the faulty computer program(s) 206. In response to the self-reliance logic/module 101 failing to respond to the second watchdog message, technique 200 proceeds to operations 214A-B. As shown, operations 214A-B include a record of the unsuccessful response to the second watchdog message being committed to the ledger 103. Operation 214A can be performed by the watchdog device 104A and operation 214B can be performed by the self-reliance logic/module 101 of the client device 102A. For one embodiment, only of one of operations 214A-B is performed. For another embodiment, both operations 214A-B are performed.

Next, technique 200 proceeds to operation 215, where the self-reliance logic/module 101 of the client device 102A detects that the computer program(s) 206 are faulty or failing. The detection can be performed in response to the self-reliance logic/module 101 performing operation 214B. Alternatively, or additionally, the detection can be performed in response to the self-reliance logic/module 101 inspecting the ledger 103 after one or more of operations 214A-B. After operation 215, technique 200 proceeds to operation 216. Here, the self-reliance logic/module 101 initiates software recovery service(s) 199, which are described in connection with FIG. 3.

Referring briefly to FIG. 3, which includes additional details about software recovery service(s) 199 illustrated in one or more of FIGS. 1 and 2. There can be different types of software recovery service(s) 199—(i) service(s) 199 that are internal to the client device 102A; and (ii) service(s) 199 that are external (at least in part) to the client device 102A. One example of service(s) 199 that are internal to the client device 102A includes use of the image 207, as shown by service 302 in FIG. 3. For one embodiment, the service 302 includes the image 207 of the computer program(s) 206 being used by the logic/module 101 for performing software recovery. For example, the logic/module 101 may automatically replace the faulty program(s) 206 with the known good configuration of the program(s) in the image 207. In this way, the self-reliance logic/module 101 can assist with enabling the client device 102A to engage in recovery without requiring user intervention or communication with external types of service(s) 199. During performance of service 302, the self-reliance logic/module responds to any watchdog messages as the faulty computer program(s) are being replaced with the known good computer program(s) from the replicant image. Another example of service(s) 199 that are internal to the client device 102A includes decommissioning the client device 102A, as shown by service 305 in FIG. 3. Decommissioning a device (e.g., the client device 102A) includes operatively uncoupling the device from a computer system that is comprised of multiple interconnected programmable devices (e.g., system 100, etc.). One example of service(s) 199 that are at least partially external to the client device 102A includes transferring one or more operations performed by the failed client device 102A to a nearby or available client device within the computer system comprised of interconnected programmable devices, as shown by service 303 in FIG. 3. Another example of service(s) 199 that are at least partially external to the client device 102A includes dispatching a replacement device or servicing entity (e.g., technicians, drones, delivery trucks, etc.) to the client device 102A's location to fix and/or replace the client device 102A, as shown by service 304 in FIG. 3. For one embodiment, any of the service(s) 199 described above in connection with one or more FIGS. 1-3 can be combined with one or more of the other service(s) 199.

With regard again to FIG. 2, the illustrated embodiment of the client device 102A includes an auxiliary power source 205 for powering the logic/module 101 independently of the other component(s) 130A of the client device 102A. For one embodiment, the auxiliary power source 205 is used when, for example, the client device 102A is no longer operational due to the faulty operation of the computer program(s) 206, when the main power source (not shown) of the client device 102A is not supplying power to the client device 102A due to the faulty operation of the computer program(s) 206, etc. In this way, the auxiliary power source 205 can enable the logic/module 101 to perform operation 216 (i.e., initiation of service(s) 199) even when the main power source (not shown) of the client device 102A is not supplying power to the client device 102A. The power source 205 can include a capacitor, a battery, a solar cell, a fuel cell, or any other power source capable as acting as an alternate power source. For a specific embodiment, an auxiliary power source 205 can be configured to power one or more tamper resistant processors that are used to implement a self-reliance logic/module 101 independently of other components of the client device 102A. Tamper resistant processors are described in connection with FIG. 1.

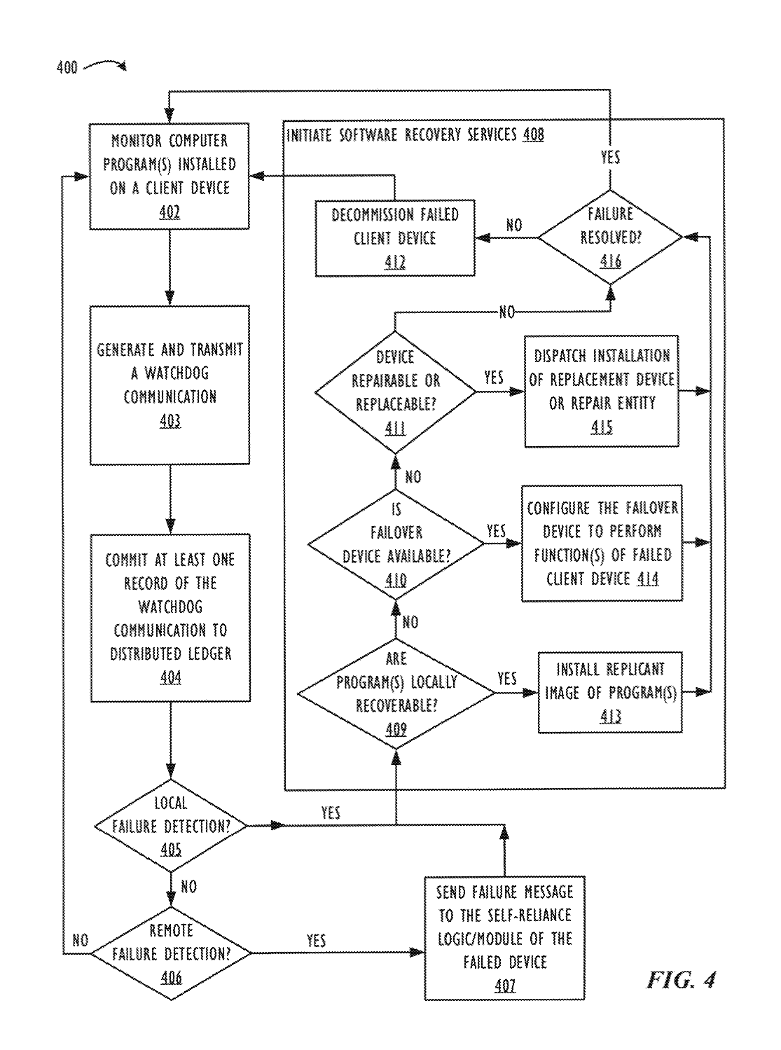

Referring now to FIG. 4, which is a flowchart illustrating a technique 400 for software recovery of a computer program using a distributed ledger 103 in accord with one embodiment. The technique 400 can be performed by one or more elements of the system 100 described above in connection FIG. 1. For example, a TEE implementing a self-reliance logic/module (e.g., the self-reliance logic/module 101 described above in connection with FIG. 1, etc.). Technique 400 includes one or more elements described above in connection with FIGS. 1-3. For brevity, some of these elements are not described again.

A self-reliance logic/module of any one of the client devices 102A-N (e.g., one or more of the logic/modules 101) may perform the technique 400 when the watchdog devices 104A-B and the client devices 102A-N have a contract to communicate watchdog messages with each other. For one embodiment, each contract can be a smart contract—that is, a state stored in the blockchain represented as the distributed ledger 103 that facilitates, authenticates, and/or enforces performance of a contract between the watchdog devices 104A-B and the client devices 102A-N. Consequently, a smart contract is one feature of the ledger 103, as a blockchain, that can assist the one or more self-reliance logic/modules 101 with locating faulty or flawed computer program(s) installed in one or more of the client devices 102A-N. This is beneficial because a smart contract can enable the ledger 103 to remain stable, even as account servicing roles are transferred or passed between the watchdog devices 104A-B. Technique 400, as described below and in connection with FIG. 4, includes one or more examples of a smart contract between the watchdog devices 104A-B and the client devices 102A-N.

Technique 400 begins at operation 402, where a self-reliance logic/module of the client device 102A monitors a computer program installed on a client device 102A with the ledger 103. For one embodiment, SCM techniques as described above in connection with FIG. 1 are used by the self-reliance logic/module for monitoring of the client device 102A. Additionally, or alternatively, operation 402 can include one or more watchdog devices 104A-B transmitting a watchdog communications (e.g., a watchdog message, etc.) to the client device 102A to monitor the installed computer program's functioning on the client device 102A.

Operation 403 includes the client device 102A generating a watchdog communication (e.g., a watchdog response message, etc.) and transmitting the watchdog communication to one or more watchdog devices 104A-B. For one embodiment, operation 403 is performed in accord with one or more of FIGS. 1-3. For another embodiment, operation 403 may be performed with or without receiving any watchdog communications (e.g., watchdog messages, etc.) from the watchdog devices 104A-B. For this embodiment, the client device 102A generates and transmits a watchdog communication (e.g., a watchdog response message, etc.) according to a predetermined schedule (e.g., every hour, every second, every two days, any time period used for scheduled behavior, etc.).

Technique 400 proceeds to operation 404, where one or more records of the watchdog communication are committed to the distributed ledger 103. For one embodiment, the one or more records include one or more of: (i) a record of a transmitted watchdog response message, which can be committed to the ledger 103 by the client device 102A; (ii) a record of a received watchdog response message, which can be committed to the ledger 103 by the one of watchdog devices 104A-N that received the watchdog response message; (iii) a record of a transmitted watchdog message, which can be committed to the ledger 103 by the one of watchdog devices 104A-N that transmitted the watchdog message; and (iv) a record of a received watchdog message, which can be committed to the ledger 103 by the client device 102A that received the watchdog message.

Next, at operation 405, the self-reliance logic/module of the client device 102A can detect whether the client device 102A has failed due to faulty computer program(s) installed thereon. Local failure detection refers to the self-reliance logic/module of the client device 102A determining that faulty computer program(s) installed thereon have caused the client device 102A to fail. Local detection is determined based on inspecting the ledger 103 and/or on internal SCM techniques, for example, as described above in accord with FIGS. 1-3. If local failure is not detected, then technique 400 proceeds to operation 406, where the self-reliance logic/module of the client device 102A can detect, based on inspecting the ledger 103, whether any of the other client devices 102B-N in the system 100 has failed due to faulty computer program(s) installed thereon. Remote failure detection refers to the self-reliance logic/module of the client device 102A determining that faulty computer program(s) installed on one or more other client devices 102B-N have caused these other one(s) of the client devices 102B-N to fail. Remote detection is determined based on inspecting the ledger 103. Remote detection can, for example, be performed in accord with FIGS. 1-3 as described above. If remote failure is not detected, then technique 400 returns to operation 402.

Technique 400 proceeds to operation 407 when remote failure is detected. Here, the self-reliance logic/module of the client device 102A transmits a failure message to the self-reliance logic/module of the failed device, which can cause the self-reliance logic/module of the failed device to trigger software recovery service(s) as described below in connection with operation 408 (or above in connection with one or more of FIGS. 1-3). Furthermore, technique 400 proceeds to operation 408 when local failure is detected or after operation 407 is performed. Operation 408 includes initiations of one or more software recovery service(s), which are described above in further detail in connection with at least FIG. 3. For one embodiment of technique 400, operation 408 includes operations 409-416.

Operation 409 includes the self-reliance logic/module of the client device 102A determining whether the flawed computer program(s) installed on the client device 102A can be recovered locally using data from the client device 102A. An example of such data is the replicant image 207 of FIG. 2, which is described above. For an embodiment, operation 409 is performed by the self-reliance logic/module of the client device 102A inspecting the client device 102A for a replicant image of the program(s), which is the last known good configuration of the installed computer program(s). When the replicant image exists, technique 400 moves to operation 413. Here, the self-reliance logic/module of the client device 102A replaces the flawed program(s) with the known good program(s) from the image. For an embodiment, operation 413 is performed in accord with at least FIGS. 2-3, which are described above. Alternatively, technique 400 moves to operation 410 when the replicant image cannot be located by the self-reliance logic/module of the client device 102A or when the replicant image cannot be successfully used to rollback the faulty program(s). Here, a determination is made as to whether a failover device (i.e., one or more of the client devices 102B-N) can take over the performance of one or more operations performed by the failed client device 102A. For one embodiment, the self-reliance logic/module of the client device 102 can transmit a failover message to one or more of the client devices 102B-N in the system 100 requesting computational resources for taking over operations of the client device 102A. In response, the self-reliance logic/module(s) of the client devices 102B-N can inspect the client devices 102B-N for available resources of the client devices 102B-N, and transmit a failover response message back to the self-reliance logic/module of the client device 102A indicating availability or lack thereof. After receiving the failover response messages, the self-reliance logic/module of the client device 102A selects one or more of the client devices 102B-N having sufficient available resources as a failover device. Any technique for selecting failover device can be used. It is to be appreciated that “sufficient resources” can vary depending on the operations to be performed. At operation 414, technique 400 includes configuring the failover device(s) to perform operations of the failed client device 102A.

When a failover device is unavailable, technique 400 proceeds to operation 411. Here, a determination is made as to whether the failed client device 102A is repairable by a servicing entity (e.g., a service technician, a drone, etc.) or replaceable by an entity (e.g., a service technician, a drone, a delivery vehicle, etc.). When the failed client device 102A is repairable or replaceable, then technique 400 proceeds to operation 415. Here, the self-reliance logic/module(s) of the client device 102A communicates via the network(s) 105 with the appropriate service facility to dispatch installation of replacement device or servicing of the failed client device 102A. For one embodiment, operation 415 is performed automatically and/or without a user of the client device 102A initiating communication with the appropriate service facility.

Technique 400 also includes operation 416, which occurs after operations 411 and 413-415 have been performed. For an embodiment, technique 400 proceeds to operation 416 from operation 411 whether or not operation 415 can be performed. For one embodiment, technique 400 proceeds to operation 416 after performance of operations 413-415. At operation 416, a determination is made as to whether the failure of the program(s) has been resolved. When the failure has been resolved, then technique 400 returns to operation 402 (which is described above). Alternatively, when the failure has not been resolved, then technique 400 proceeds to operation 412. Here, the failed client device 102A is decommissioned. For one embodiment, the self-reliance logic/module of the client device 102A decommissions the client device 102A. For another embodiment, the self-reliance logic/module of the client device 102A communicates with the appropriate entities (e.g., an enterprise IT service facility, etc.) that can perform the decommissioning process via network(s) 105.

For one embodiment, the ledger 103 can be generated during operation 402 by creating a genesis block (when the ledger 103 lacks any blocks) or appending a block to an already existing ledger 103. For one embodiment, a self-reliance logic/module registers the client devices 102A-N and/or the watchdog devices 104A-N with the ledger 103 by committing, to the ledger 103, a record of a communicated watchdog message and/or a record of a communicated watchdog response message.

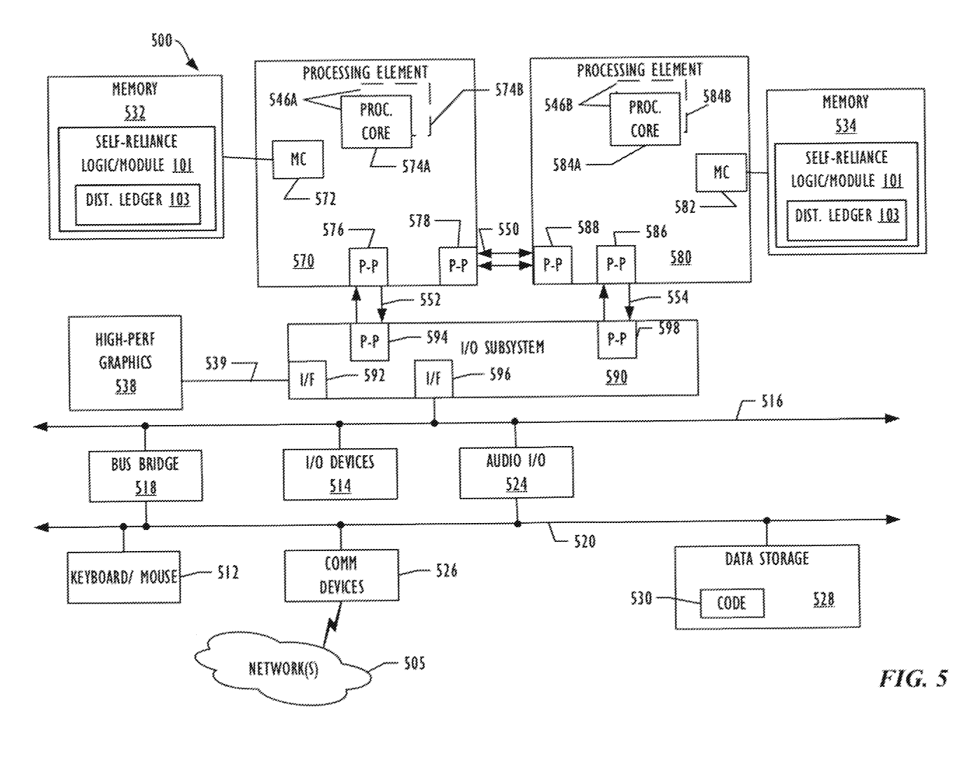

FIG. 5 is a block diagram that illustrates a programmable device 500, which may be used to implement the techniques described herein in accordance with one or more embodiments (e.g., system 100 and techniques 200, 300, and 400). The programmable device 500 illustrated in FIG. 5 is a multiprocessor programmable device that includes a first processing element 570 and a second processing element 580. While two processing elements 570 and 580 are shown, an embodiment of programmable device 500 may also include only one such processing element or more two of such processing elements.

Programmable device 500 is illustrated as a point-to-point interconnect system, in which the first processing element 570 and second processing element 580 are coupled via a point-to-point interconnect 550. Any or all of the interconnects illustrated in FIG. 5 may be implemented as a multi-drop bus rather than point-to-point interconnects.

As illustrated in FIG. 5, each of processing elements 570 and 580 may be multicore processors, including first and second processor cores (i.e., processor cores 574A and 574B and processor cores 584A and 584B). Such cores 574A, 574B, 584A, 584B may be configured to execute computing instruction code. However, other embodiments may use processing elements that are single core processors as desired. In embodiments with multiple processing elements 570, 580, each processing element may be implemented with different numbers of cores as desired.

Each processing element 570, 580 may include at least one shared cache 546. The shared cache 546A, 546B may store data (e.g., computing instructions) that are utilized by one or more components of the processing element, such as the cores 574A, 574B and 584A, 584B, respectively. For example, the shared cache may locally cache data stored in a memory 532, 534 for faster access by components of the processing elements 570, 580. For one or more embodiments, the shared cache 546A, 546B may include one or more mid-level caches, such as level 2 (L2),level 3 (L3),level 4 (L4), or other levels of cache, a last level cache (LLC), or combinations thereof. The memory 532, 534 may include software instructions representing one or more self-reliance logic/modules 101, which include a distributed ledger 103 that is accessible by each of the processing elements 570 and 580. Each of the logic/modules 101 and the distributed ledger 103 is described above in connection with at least FIG. 1, 2, 3, or 4.

While FIG. 5 illustrates a programmable device with two processing elements 570, 580 for clarity of the drawing, the scope of the present invention is not so limited and any number of processing elements may be present. Alternatively, one or more of processing elements 570, 580 may be an element other than a processor, such as an graphics processing unit (GPU), a digital signal processing (DSP) unit, a field programmable gate array, or any other programmable processing element. Processing element 580 may be heterogeneous or asymmetric to processing element 570. There may be a variety of differences between processing elements 570, 580 in terms of a spectrum of metrics of merit including architectural, microarchitectural, thermal, power consumption characteristics, and the like. These differences may effectively manifest themselves as asymmetry and heterogeneity amongst processing elements 570, 580. In some embodiments, the various processing elements 570, 580 may reside in the same die package.

First processing element 570 may further include memory controller (MC) logic 572 and point-to-point (P-P) interconnects 576 and 578. Similarly, second processing element 580 may include a MC 582 and P-P interconnects 586 and 588. As illustrated in FIG. 5, MC logic 572 and MC logic 582 couple processing elements 570, 580 to respective memories, namely a memory 532 and a memory 534, which may be portions of main memory locally attached to the respective processors. While MC logic 572 and MC logic 582 are illustrated as integrated into processing elements 570, 580, in some embodiments the memory controller logic may be discrete logic outside processing elements 570, 580 rather than integrated therein.

Processing element 570 and processing element 580 may be coupled to an I/O subsystem 590 via respective P-P interconnects 576 and 586 through links 552 and 554. As illustrated in FIG. 5, I/O subsystem 590 includes P-P interconnects 594 and 598. Furthermore, I/O subsystem 590 includes an interface 592 to couple I/O subsystem 590 with a high performance graphics engine 538. In one embodiment, a bus (not shown) may be used to couple graphics engine 538 to I/O subsystem 590. Alternately, a point-to-point interconnect 539 may couple these components.

In turn, I/O subsystem 590 may be coupled to a first link 516 via an interface 596. In one embodiment, first link 516 may be a Peripheral Component Interconnect (PCI) bus, or a bus such as a PCI Express bus or another I/O interconnect bus, although the scope of the present invention is not so limited.

As illustrated in FIG. 5, various I/O devices 514, 524 may be coupled to first link 516, along with a bridge 518 that may couple first link 516 to a second link 520. In one embodiment, second link 520 may be a low pin count (LPC) bus. Various devices may be coupled to second link 520 including, for example, a keyboard/mouse 512, communication device(s) 526 (which may in turn be in communication with one or more other programmable devices via one or more networks 505), and a data storage unit 528 such as a disk drive or other mass storage device which may include code 530, for one embodiment. The code 530 may include instructions for performing embodiments of one or more of the techniques described above. Further, an audio I/O 524 may be coupled to second link 520.

Note that other embodiments are contemplated. For example, instead of the point-to-point architecture of FIG. 5, a system may implement a multi-drop bus or another such communication topology. Although links 516 and 520 are illustrated as busses in FIG. 5, any desired type of link may be used. In addition, the elements of FIG. 5 may alternatively be partitioned using more or fewer integrated chips than illustrated in FIG. 5.

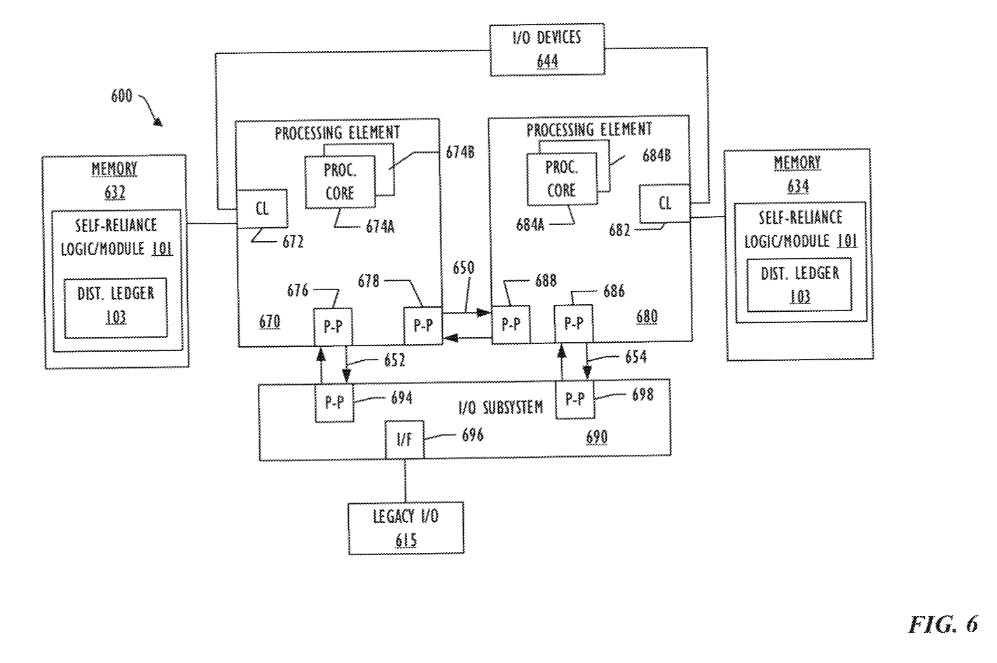

FIG. 6 is a block diagram illustrating a programmable device 600 for use with techniques described herein according to another embodiment. Certain aspects of FIG. 6 have been omitted from FIG. 6 in order to avoid obscuring other aspects of FIG. 6.

FIG. 6 illustrates that processing elements 670, 680 may include integrated memory and I/O control logic (“CL”) 672 and 682, respectively. In some embodiments, the 672, 682 may include memory control logic (MC) such as that described above in connection with FIG. 6. In addition, CL 672, 682 may also include I/O control logic. FIG. 6 illustrates that not only may the memories 632, 634 be coupled to the CL 672, 682, but also that I/O devices 644 may also be coupled to the control logic 672, 682. Legacy I/O devices 615 may be coupled to the I/O subsystem 690 by interface 696. Each processing element 670, 680 may include multiple processor cores, illustrated in FIG. 6 as processor cores 674A, 674B, 684A, and 684B. As illustrated in FIG. 6, I/O subsystem 690 includes point-to-point (P-P) interconnects 694 and 698 that connect to P-P interconnects 676 and 686 of the processing elements 670 and 680 with links 652 and 654. Processing elements 670 and 680 may also be interconnected by link 650 and interconnects 678 and 688, respectively. The memory 632, 634 may include software instructions representing one or more self-reliance logic/modules 101, which include a distributed ledger 103, that is accessible and/or executable by each of the processing elements 670 and 680. Each of the logic/modules 101 and the distributed ledger 103 is described above in connection with at least FIG. 1, 2, 3, or 4.

The programmable devices depicted in FIGS. 5 and 6 are schematic illustrations of embodiments of programmable devices that may be utilized to implement various embodiments discussed herein. Various components of the programmable devices depicted in FIGS. 5 and 6 may be combined in a system-on-a-chip (SoC) architecture.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, tangible, non-transitory memories such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

The following examples pertain to further embodiments.

Example 1 includes a machine readable medium storing instructions for recovery of a program installed on a client device, comprising instructions that when executed cause a watchdog device to: transmit, to the client device, a request for an indication of an expected operation of a program installed on the client device; commit, to a distributed ledger on a plurality of interconnected devices, a first record responsive to receiving a response to the request from the client device within a predetermined period of time, the client device and the watchdog device being among the plurality of interconnected devices; commit, to the distributed ledger, a second record responsive to not receiving a response to the request within the predetermined period of time; and initiate a software recovery service for the client device responsive to committing the second record.

In Example 2, the subject matter of example 1 can optionally include that the instructions further comprise instructions that when executed cause the watchdog device to commit the request to the distributed ledger.

In Example 3, the subject matter of claim 1 or 2 can optionally include that the software recovery service for the client device includes one or more of the following: a first software recovery service that includes replacing the program with a known configuration of the program stored in an image; a second software recovery service that includes transferring one or more operations performed by the client device to a second client device, the second client device being one of the plurality of interconnected devices; a third software recovery service that includes decommissioning the client device; and a fourth software recovery service that includes dispatching a replacement device to replace the client device or a servicing entity to repair the client device.

In Example 4, the subject matter of claim 1, 2, or 3 can optionally include that the distributed ledger stores records of successful responses and indications of failure to respond in separate blocks of a blockchain.

In Example 5, the subject matter of claim 1, 2, 3, or 4 can optionally include that each transmitted response is generated according to a predetermined schedule.

In Example 6, the subject matter of claim 1, 2, 3, 4, or 5 can optionally include that the watchdog device includes at least one tamper resistant processor for executing at least some of the instructions in a secure environment in order to minimize or prevent security vulnerabilities.

In Example 7, the subject matter of claim 1, 2, 3, 4, 5, or 6 can optionally include that the instructions further comprise instructions than when executed cause the watchdog device to: determine, based on the distributed ledger, that the program is faulty.

Example 8 includes a method for recovery of a program installed on a client device, the method comprising: transmitting, to the client device and by a watchdog device, a request for an indication of an expected operation of a program installed on the client device; committing, to a distributed ledger on a plurality of interconnected devices, a first record responsive to receiving a response to the request from the client device within a predetermined period of time, the client device and the watchdog device being among the plurality of interconnected devices; committing, to the distributed ledger, a second record responsive to not receiving a response to the request within the predetermined period of time; and initiating a software recovery service for the client device responsive to committing the second record.

In Example 9, the subject matter of claim 8 can optionally include that the method further comprises committing the request to the distributed ledger.

In Example 10, the subject matter of claim 8 or 9 can optionally include that the software recovery service for the client device includes one or more of the following: a first software recovery service that includes replacing the program with a known configuration of the program stored in an image; a second software recovery service that includes transferring one or more operations performed by the client device to a second client device, the second client device being one of the plurality of interconnected devices; a third software recovery service that includes decommissioning the client device; and a fourth software recovery service that includes dispatching a replacement device to replace the client device or a servicing entity to repair the client device.

In Example 11, the subject matter of claim 8, 9, or 10 can optionally include that the distributed ledger stores records of successful responses and indications of failure to respond in separate blocks of a blockchain.

In Example 12, the subject matter of claim 8, 9, 10, or 11 can optionally include that each transmitted response is generated according to a predetermined schedule.

In Example 13, the subject matter of claim 8, 9, 10, 11, or 12 can optionally include that the method further comprises determining, based on the distributed ledger, that the program is faulty.

Example 14 includes watchdog device for recovery of a program installed on a client device, the watchdog device comprising: one or more processors; and a memory coupled to the one or more processors and storing instructions, comprising instructions that when executed cause the one or more processors to: transmit, to the client device, a request for an indication of an expected operation of a program installed on the client device; commit, to a distributed ledger on a plurality of interconnected devices, a first record responsive to receiving a response to the request from the client device within a predetermined period of time, the client device and the watchdog device being among the plurality of interconnected devices; commit, to the distributed ledger, a second record responsive to not receiving a response to the request within the predetermined period of time; and initiate a software recovery service for the client device responsive to committing the second record.

In Example 15, the subject matter of claim 14 can optionally include that the instructions further comprise instructions that when executed cause the one or more processors to commit the request to the distributed ledger.

In Example 16, the subject matter of claim 14 or 15 can optionally include that the software recovery service for the client device includes one or more of the following: a first software recovery service that includes replacing the program with a known configuration of the program stored in an image; a second software recovery service that includes transferring one or more operations performed by the client device to a second client device, the second client device being one of the plurality of interconnected devices; a third software recovery service that includes decommissioning the client device; and a fourth software recovery service that includes dispatching a replacement device to replace the client device or a servicing entity to repair the client device.

In Example 17, the subject matter of claim 14, 15, or 16 can optionally include that the distributed ledger stores records of successful responses and indications of failure to respond in separate blocks of a blockchain.

In Example 18, the subject matter of claim 14, 15, 16, or 17 can optionally include that each transmitted response is generated according to a predetermined schedule.

In Example 19, the subject matter of claim 14, 15, 16, 17, or 18 can optionally include that the one or more processors includes at least one tamper resistant processor for executing at least some of the instructions in a secure environment in order to minimize or prevent security vulnerabilities.

In Example 20, the subject matter of claim 14, 15, 16, 17, 18, or 19 can optionally include that the instructions further comprise instructions than when executed cause the one or more processors to determine, based on the distributed ledger, that the program is faulty.

Example 21 includes a machine readable medium storing instructions for recovery of a program installed on a client device, comprising instructions that when executed cause the client device to: transmit, to a watchdog device, a message indicating an expected operation of a program installed on the client device; commit, to a distributed ledger on a plurality of interconnected devices, a first record responsive to transmitting the message to the watchdog device within a predetermined period of time, the client device and the watchdog device being among the plurality of interconnected devices; commit, to the distributed ledger, a second record responsive to not transmitting the message to the watchdog device within the predetermined period of time; and initiate a software recovery service for the client device responsive to committing the second record.

Example 22 includes a method for recovery of a program installed on a client device, the method comprising: transmitting, by the client device and to a watchdog device, a message indicating an expected operation of a program installed on the client device; committing, to a distributed ledger on a plurality of interconnected devices, a first record responsive to transmitting the message to the watchdog device within a predetermined period of time, the client device and the watchdog device being among the plurality of interconnected devices; committing, to the distributed ledger, a second record responsive to not transmitting the message to the watchdog device within the predetermined period of time; and initiating a software recovery service for the client device responsive to committing the second record.

Example 23 includes a client device for recovery of an installed program, comprising: one or more processors; and a memory coupled to the one or more processors and storing instructions, wherein the instructions comprise instructions than when executed causes at least some of the one or more processors to: transmit, to a watchdog device, a message indicating an expected operation of a program installed on the client device; commit, to a distributed ledger on a plurality of interconnected devices, a first record responsive to transmitting the message to the watchdog device within a predetermined period of time, the client device and the watchdog device being among the plurality of interconnected devices; commit, to the distributed ledger, a second record responsive to not transmitting the message to the watchdog device within the predetermined period of time; and initiate a software recovery service for the client device responsive to committing the second record.

In Example 24, the subject matter of claim 23 can optionally include that the one or more processors includes at least one tamper resistant processor for executing at least some of the instructions in a secure environment in order to minimize or prevent security vulnerabilities.

In Example 25, the subject matter of claim 23 or 24 can optionally include that the client device further comprises: an auxiliary power source configured to power the tamper resistant processor independently of other components of the client device.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

In this document, reference has been made to blockchain technologies, such as ethereum and bitcoin. ETHEREUM may be a trademark of the Ethereum Foundation (Stiftung Ethereum). BITCOIN may be a trademark of the Bitcoin Foundation. These and any other marks referenced herein may be common law or registered trademarks of third parties affiliated or unaffiliated with the applicant or the assignee. Use of these marks is by way of example and shall not be construed as descriptive or to limit the scope of the embodiments described herein to material associated only with such marks.

What is claimed is:

1. A machine readable medium storing instructions for recovery of a program installed on a client device, comprising instructions that when executed cause a watchdog device to:
transmit, to the client device, a request for an indication of an expected operation of a program installed on the client device;
commit, to a distributed ledger on a plurality of interconnected devices, a first record responsive to receiving a response to the request from the client device within a predetermined period of time, the client device and the watchdog device being among the plurality of interconnected devices;
commit, to the distributed ledger, a second record responsive to not receiving a response to the request within the predetermined period of time; and
initiate a software recovery service for the client device responsive to committing the second record.

2. The machine readable medium of claim 1, wherein the instructions further comprise instructions that when executed cause the watchdog device to commit the request to the distributed ledger.

3. The machine readable medium of claim 1, wherein the software recovery service for the client device includes one or more of the following:
a first software recovery service that includes replacing the program with a known configuration of the program stored in an image;
a second software recovery service that includes transferring one or more operations performed by the client device to a second client device, the second client device being one of the plurality of interconnected devices;
a third software recovery service that includes decommissioning the client device; and
a fourth software recovery service that includes dispatching a replacement device to replace the client device or a servicing entity to repair the client device.

4. The machine readable medium of claim 1, wherein the distributed ledger stores records of successful responses and indications of failure to respond in separate blocks of a blockchain.

5. The machine readable medium of claim 4, wherein each transmitted response is generated according to a predetermined schedule.

6. The machine readable medium of claim 1, wherein the watchdog device includes at least one tamper resistant processor for executing at least some of the instructions in a secure environment in order to minimize or prevent security vulnerabilities.

7. The machine readable medium of claim 1, wherein the instructions further comprise instructions than when executed cause the watchdog device to:
determine, based on the distributed ledger, that the program is faulty.

8. A method for recovery of a program installed on a client device, the method comprising:
transmitting, to the client device and by a watchdog device, a request for an indication of an expected operation of a program installed on the client device;
committing, to a distributed ledger on a plurality of interconnected devices, a first record responsive to receiving a response to the request from the client device within a predetermined period of time, the client device and the watchdog device being among the plurality of interconnected devices;
committing, to the distributed ledger, a second record responsive to not receiving a response to the request within the predetermined period of time; and
initiating a software recovery service for the client device responsive to committing the second record.

9. The method of claim 8, further comprising committing the request to the distributed ledger.

10. The method of claim 8, wherein the software recovery service for the client device includes one or more of the following:
a first software recovery service that includes replacing the program with a known configuration of the program stored in an image;
a second software recovery service that includes transferring one or more operations performed by the client device to a second client device, the second client device being one of the plurality of interconnected devices;
a third software recovery service that includes decommissioning the client device; and
a fourth software recovery service that includes dispatching a replacement device to replace the client device or a servicing entity to repair the client device.

11. The method of claim 8, wherein the distributed ledger stores records of successful responses and indications of failure to respond in separate blocks of a blockchain.

12. The method of claim 11, wherein each transmitted response is generated according to a predetermined schedule.

13. The method of claim 8, further comprising determining, based on the distributed ledger, that the program is faulty.

14. A watchdog device for recovery of a program installed on a client device, the watchdog device comprising:
one or more processors; and
a memory coupled to the one or more processors and storing instructions, comprising instructions that when executed cause the one or more processors to:
transmit, to the client device, a request for an indication of an expected operation of a program installed on the client device;
commit, to a distributed ledger on a plurality of interconnected devices, a first record responsive to receiving a response to the request from the client device within a predetermined period of time, the client device and the watchdog device being among the plurality of interconnected devices;
commit, to the distributed ledger, a second record responsive to not receiving a response to the request within the predetermined period of time; and
initiate a software recovery service for the client device responsive to committing the second record.

15. The watchdog device of claim 14, wherein the instructions further comprise instructions that when executed cause the one or more processors to commit the request to the distributed ledger.

16. The watchdog device of claim 14, wherein the software recovery service for the client device includes one or more of the following:
a first software recovery service that includes replacing the program with a known configuration of the program stored in an image;
a second software recovery service that includes transferring one or more operations performed by the client device to a second client device, the second client device being one of the plurality of interconnected devices;
a third software recovery service that includes decommissioning the client device; and
a fourth software recovery service that includes dispatching a replacement device to replace the client device or a servicing entity to repair the client device.

17. The watchdog device of claim 14, wherein the distributed ledger stores records of successful responses and indications of failure to respond in separate blocks of a blockchain.

18. The watchdog device of claim 17, wherein each transmitted response is generated according to a predetermined schedule.

19. The watchdog device of claim 14, wherein the one or more processors includes at least one tamper resistant processor for executing at least some of the instructions in a secure environment in order to minimize or prevent security vulnerabilities.

20. The watchdog device of claim 14, wherein the instructions further comprise instructions than when executed cause the one or more processors to determine, based on the distributed ledger, that the program is faulty.

21. A machine readable medium storing instructions for recovery of a program installed on a client device, comprising instructions that when executed cause the client device to:
transmit, to a watchdog device, a message indicating an expected operation of a program installed on the client device;
commit, to a distributed ledger on a plurality of interconnected devices, a first record responsive to transmitting the message to the watchdog device within a predetermined period of time, the client device and the watchdog device being among the plurality of interconnected devices;
commit, to the distributed ledger, a second record responsive to not transmitting the message to the watchdog device within the predetermined period of time; and
initiate a software recovery service for the client device responsive to committing the second record.

22. A method for recovery of a program installed on a client device, the method comprising:
transmitting, by the client device and to a watchdog device, a message indicating an expected operation of a program installed on the client device;
committing, to a distributed ledger on a plurality of interconnected devices, a first record responsive to transmitting the message to the watchdog device within a predetermined period of time, the client device and the watchdog device being among the plurality of interconnected devices;
committing, to the distributed ledger, a second record responsive to not transmitting the message to the watchdog device within the predetermined period of time; and
initiating a software recovery service for the client device responsive to committing the second record.

23. A client device for recovery of an installed program, comprising:
one or more processors; and
a memory coupled to the one or more processors and storing instructions, wherein the instructions comprise instructions than when executed causes at least some of the one or more processors to:
transmit, to a watchdog device, a message indicating an expected operation of a program installed on the client device;
commit, to a distributed ledger on a plurality of interconnected devices, a first record responsive to transmitting the message to the watchdog device within a predetermined period of time, the client device and the watchdog device being among the plurality of interconnected devices;
commit, to the distributed ledger, a second record responsive to not transmitting the message to the watchdog device within the predetermined period of time; and
initiate a software recovery service for the client device responsive to committing the second record.

24. The client device of claim 23, wherein the one or more processors includes at least one tamper resistant processor for executing at least some of the instructions in a secure environment in order to minimize or prevent security vulnerabilities.

25. The client device of claim 24, wherein the client device further comprises:
an auxiliary power source configured to power the tamper resistant processor independently of other components of the client device.
